(19) United States
(12) Patent Application Publication
(10) Pub. No.: US 2020/0117107 A1
(43) Pub. Date: Apr. 16, 2020

(54) POSITIVELY CHARGEABLE TONER, IMAGE FORMING APPARATUS, AND IMAGE FORMATION METHOD

(71) Applicant: KYOCERA Document Solutions Inc., Osaka (JP)

(72) Inventor: Masami TSUJIHIRO, Osaka-shi (JP)

(73) Assignee: KYOCERA Document Solutions Inc., Osaka (JP)

(21) Appl. No.: 16/592,684

(22) Filed: Oct. 3, 2019

(30) Foreign Application Priority Data
Oct. 10, 2018 (JP) 2018-191675

(51) Int. Cl. G03G 9/08; G03G 9/083; G03G 9/087; G03G 9/097

(52) U.S. Cl. CPC G03G 9/0823; G03G 9/0825; G03G 9/09741; G03G 9/08755; G03G 9/0833

(57) ABSTRACT

A positively chargeable toner includes toner particles. The toner particles each include a toner mother particle and an external additive attached to a surface of the toner mother particle. The toner mother particle includes a polyester resin having an acid value of at least 10.0 mgKOH/g, a compound having a quaternary ammonium cation group, and strontium titanate particles. The external additive includes no strontium titanate particles.

### INCORPORATION BY REFERENCE

The present application claims priority under 35 U.S.C. § 119 to Japanese Patent Application No. 2018-191675, filed on Oct. 10, 2018. The contents of this application are incorporated herein by reference in their entirety.

### BACKGROUND

The present disclosure relates to a positively chargeable toner, an image forming apparatus, and an image formation method.

In electrophotography, the surface of an electrophotographic photosensitive member that is an image bearing member (also referred to below as a photosensitive member) is charged and then exposed to light to form an electrostatic latent image on the photosensitive member. Subsequently, the electrostatic latent image is developed with a toner into a toner image, and the toner image is transferred to a recording medium. The toner image on the recording medium is fixed by a fixing device to form an image on the recording medium.

In a case where an image formation process by electrophotography is performed, ionic materials (for example, a discharge product generated in charging the photosensitive member) may adhere to the surface of the photosensitive member. When image formation is performed in a high-humidity environment in such a situation, electric resistance of the surface of the photosensitive member decreases due to the presence of the ionic materials to cause turbulent of latent image charge on the photosensitive member. As a result, image flow (specifically, a phenomenon in which an image flows like being rubbed to be blurred) may occur.

To address an image flow as described above, it is examined to add particles having an abrasion function (also referred to below as an abrasive) to a toner as an external additive. For example, when titanium oxide particles are used as an external additive, occurrence of an image flow can be inhibited by removing ionic materials adhering to the surface of the photosensitive member through use of the externally added titanium oxide particles.

However, the titanium oxide particles may bar compliance to a regulation relating to Registration, Evaluation, Authorisation and Restriction of Chemicals (REACH) in European Union, and therefore, an abrasive that is a substitute of the titanium oxide particles is desired.

A toner is examined to which strontium titanate particles are externally added as an abrasive other than the titanium oxide particles.

### SUMMARY

A positively chargeable toner according to an aspect of the present disclosure includes toner particles. The toner particles each include a toner mother particle and an external additive attached to a surface of the toner mother particle. The toner mother particle includes a binder resin, a positively chargeable charge control agent, and strontium titanate particles. The binder resin includes a polyester resin having an acid value of at least 10.0 mgKOH/g. The positively chargeable charge control agent contains a compound having a quaternary ammonium cation group. The external additive includes no strontium titanate particles.

An image forming apparatus according to an aspect of the present disclosure includes an image bearing member, a development device, and a transfer section. The development device develops an electrostatic latent image formed on a surface of the image bearing member into a toner image by supplying the positively chargeable toner of the aspect of the present disclosure to the electrostatic latent image. The transfer section transfers the toner image to a transfer target.

An image formation method according to an aspect of the present disclosure includes developing and transferring. In the developing, an electrostatic latent image formed on a surface of an image bearing member is developed into a toner image by supplying the positively chargeable toner of the aspect of the present disclosure to the electrostatic latent image. In the transferring, the toner image is transferred to a transfer target.

### BRIEF DESCRIPTION OF THE DRAWINGS

FIG. 1 is a diagram illustrating an example of a cross-sectional structure of a toner particle included in a positively chargeable toner according to a first embodiment of the present disclosure.

FIG. 2 is a diagram illustrating an example of an image forming apparatus according to a second embodiment of the present disclosure.

### DETAILED DESCRIPTION

The following describes a preferable embodiment of the present disclosure. First of all, terms used in the present specification will be described. A toner is a collection (for example, a powder) of toner particles. The external additive is a collection (for example, a powder) of external additive particles. Results of evaluation (values representing shape and physical properties) for a powder (specific examples include a powder of toner particles, a powder of external additive particles, and a powder of strontium titanate particle) each refer to a number average of values measured with respect to an appropriate number of particles selected from the powder unless otherwise stated.

A measurement value of volume median diameter (D₅₀) of a powder refers to a median diameter calculated in terms of volume measured using a laser diffraction/scattering particle size distribution analyzer (“LA-950”, product of HORIBA, Ltd.) unless otherwise stated. Values for number average primary particle diameter of a powder refer to a number average value of equivalent circle diameters of 100 primary particles of the powder (Heywood diameters: diameters of circles having the same areas as projected areas of the respective particles) measured using a scanning electron microscope (“JSM-7401F”, product of JEOL Ltd.) and image analysis software (“WinROOF”, product of MITANI Corporation) unless otherwise stated. Unless otherwise stated, a number average primary particle diameter of particles refers to a number average primary particle diameter of the particles of a powder (number average primary particle diameter of the powder).

Chargeability refers to chargeability in triboelectric charging unless otherwise stated. For example, a measurement target (for example, a toner) and a standard carrier (standard carrier for negatively chargeable toner: N-01, standard carrier for positively chargeable toner: P-01) provided by The Imaging Society of Japan are mixed and stirred together to frictionally charge the measurement target. Amounts of charge of the measurement target before and after triboelectric charging are measured for example using a compact toner draw-off charge measurement system (“MODEL 212HS”, product of TREK, INC.). A measurement target having a larger change in charge amount between before and after triboelectric charging has stronger chargeability.

A measurement value for softening point (Tm) refers to a value measured using a capillary rheometer (“CFT-500D”, product of Shimadzu Corporation) unless otherwise stated. On an S-shaped curve (vertical axis: temperature, horizontal axis: stroke) plotted using the capillary rheometer, the softening point (Tm) is a temperature corresponding to a stroke value of “(base line stroke value+maximum stroke value)/2”. A measurement value for glass transition point (Tg) refers to a value measured using a differential scanning calorimeter (“DSC-6220”, product of Seiko Instruments Inc.) in accordance with “Japanese Industrial Standard (JIS) K7121-2012”. Tg (glass transition point) of a sample corresponds to a temperature at a point of change resulting from glass transition (specifically, a temperature at an intersection point of an extrapolation of the base line and an extrapolation of the inclined portion of the curve) on a heat absorption curve (vertical axis: heat flow (DSC signal), horizontal axis: temperature) plotted using a differential scanning calorimeter.

Measurement values for acid value and hydroxyl value are values measured in accordance with neutralization titration defined in Japanese Industrial Standard (JIS) K0070-1992 unless otherwise stated.

Measurement values for number average molecular weight (Mn) and mass average molecular weight (Mw) are values measured by gel permeation chromatography unless otherwise stated.

In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. In the present description, the term “(meth)acryl” is used as a generic term for both acryl and methacryl. The term “(meth)acrylonitrile” is used as a generic term for both acrylonitrile and methacrylonitrile.

### First Embodiment: Positively Chargeable Toner

A positively chargeable toner according to the first embodiment (also referred to below as a “toner”) can be favorably used for electrostatic latent image development. The toner according to the first embodiment is a collection (for example, a powder) of toner particles (particles each having the following features). The toner may be used as a one-component developer. Alternatively, a two-component developer may be prepared by mixing the toner and a carrier using a mixer (for example, a ball mill). The toner according to the first embodiment is positively charged by friction with a carrier, a development sleeve, or a blade in a development device.

### [Features of Toner Particles]

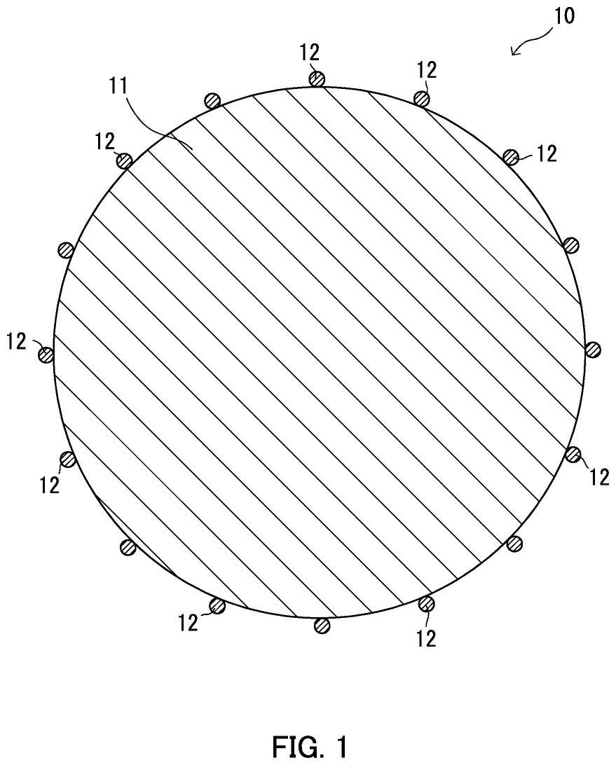

The following describes features of the toner particles included in the toner according to the first embodiment with reference to FIG. 1. FIG. 1 is a diagram illustrating an example of a cross-sectional structure of a toner particle included in the toner according to the first embodiment. FIG. 1 schematically illustrates elements of configuration in order to facilitate understanding. Properties such as size and shape and the number of the elements of configuration illustrated in the drawing may differ from actual properties and the number thereof in order to facilitate preparation of the drawing.

The toner particle 10 illustrated in FIG. 1 includes a toner mother particle 11 and an external additive 12 attached to a surface of the toner mother particle 11. The toner mother particle 11 includes a binder resin, a positively chargeable charge control agent, and strontium titanate particles. The binder resin includes a polyester resin having an acid value of at least 10.0 mgKOH/g. The positively chargeable charge control agent contains a compound having a quaternary ammonium cation group. The external additive includes no strontium titanate particles.

In the toner according to the first embodiment, the strontium titanate particles (for example, a powder of strontium titanate particles) are contained in the toner mother particle 11 as an internal additive. When an image formation process by electrophotography is performed using the toner according to the first embodiment, the strontium titanate particles (not illustrated) partially exposed at the surface of the toner mother particle 11 function as an abrasive to remove the ionic materials adhering to the surface of a photosensitive member (not illustrated). The strontium titanate particles have stronger power to adsorb ionic materials than titanium oxide particles. Accordingly, the strontium titanate particles can remove the ionic materials through adsorption of the ionic materials. Thus, the toner according to the first embodiment, which uses the strontium titanate particles as an internal additive, can remove the ionic materials, with a result that occurrence of an image flow can be inhibited.

By contrast, the inventor studied to find that a combinational use of strontium titanate particles as an abrasive and a compound having a quaternary ammonium cation group as a positively chargeable charge control agent tends to impair a function of the strontium titanate particles as an abrasive. The inventor exhaustively studied to find that a use of a binder resin including a polyester resin having an acid value of at least 10.0 mgKOH/g can inhibit impairment of the function of the strontium titanate particles as an abrasive even when the strontium titanate particles and the compound having a quaternary ammonium cation group are used in combination. That is, use of the toner according to the first embodiment, which uses a binder resin including a polyester resin having an acid value of at least 10.0 mgKOH/g, can inhibit occurrence of an image flow even when the strontium titanate particles and the compound having a quaternary ammonium cation group are used in combination.

The inventor studied to find that use of the strontium titanate particles as external additive particles makes it difficult to ensure a charge amount suitable for image formation because of a decrease in fluidity of the toner. In view of the foregoing, the external additive 12 of the toner according to the first embodiment includes no strontium titanate particles. Therefore, the toner according to the first embodiment, which inhibits lowering of fluidity, can ensure a charge amount suitable for image formation. Thus, a charge amount suitable for image formation can be ensured when the toner according to the first embodiment, which uses strontium titanate particles as an abrasive, is used.

The toner particle 10 may be a toner particle including no shell layer or a toner particle including a shell layer (also referred to below as a capsule toner). In the capsule toner particle, the toner mother particle 11 includes a toner core (not illustrated) including a binder resin, a positively chargeable charge control agent, and strontium titanate particles, and a shell layer (not illustrated) covering a surface of the toner core. The shell layer contains a resin. The toner can have for example both heat-resistant preservability and low-temperature fixability by using low-melting toner cores and highly heat-resistant shell layers covering the toner cores. An additive may be dispersed in the resin forming each shell layer. The shell layers may cover the entire surfaces of the toner cores or partially cover the surfaces of the toner cores.

In order to obtain a toner suitable for image formation in the first embodiment, the toner mother particles 11 preferably have a volume median diameter (D₅₀) of at least 4 μm and no greater than 9 μm.

In order to further inhibit occurrence of an image flow in the first embodiment, the toner mother particle 11 preferably includes the strontium titanate particles in an amount of at least 5.0 parts by mass relative to 100 parts by mass of the binder resin. In order to obtain a toner having excellent low-temperature fixability while easily ensuring a charge amount suitable for image formation in the first embodiment, the toner mother particle 11 preferably includes the strontium titanate particles in an amount of no greater than 20.0 parts by mass relative to 100 parts by mass of the binder resin, and more preferably no greater than 10.0 parts by mass.

In order to further inhibit occurrence of an image flow in the first embodiment, the strontium titanate particles preferably have a number average primary particle diameter of at least 360 nm, and more preferably have a number average primary particle diameter of at least 380 nm. In order to easily ensure a charge amount suitable for image formation in the first embodiment, the strontium titanate particles preferably have a number average primary particle diameter of no greater than 800 nm, and more preferably have a number average primary particle diameter of no greater than 600 nm.

In order to easily ensure a charge amount suitable for image formation in the first embodiment, the polyester resin preferably has an acid value of no greater than 20.0 mgKOH/g. The acid value of the polyester resin can be adjusted for example by changing at least one of a reaction time for synthesis of the polyester resin and an additive amount of a cross-linking agent which will be described later in Examples.

In order to easily comply with the REACH regulation, the toner particle 10 preferably includes no titanium oxide particles.

As described above, the toner mother particle 11 includes a binder resin, a positively chargeable charge control agent, and strontium titanate particles. The toner mother particle 11 may further contain an internal additive (for example, at least one of a colorant, a releasing agent, and a magnetic powder) other than the positively chargeable charge control agent and the strontium titanate particles.

An example of the toner particles included in the toner according to the first embodiment has been described so far with reference to FIG. 1. The following describes elements of the toner particles included in the toner according to the first embodiment.

### [Elements of Toner Particle]

### (Binder Resin)

The binder resin includes a polyester resin having an acid value of at least 10.0 mgKOH/g. In order to further inhibit occurrence of an image flow, the toner mother particle contains a polyester resin having an acid value of at least 10.0 mgKOH/g preferably in an amount of at least 80% by mass relative to a total mass of the binder resin, more preferably in an amount of at least 90% by mass, and further preferably in an amount of at least 95% by mass and no greater than 100% mass.

The polyester resin can be obtained through condensation polymerization of at least one polyhydric alcohol and at least one polybasic carboxylic acid. Examples of polyhydric alcohols that can be used for synthesis of the polyester resin include dihydric alcohols (specific examples include diols and bisphenols) and tri- or higher-hydric alcohols listed below. Examples of polybasic carboxylic acids that can be used for synthesis of the polyester resin include dibasic carboxylic acids and tri- or higher-basic carboxylic acids listed below. Note that a polybasic carboxylic acid derivative such as an anhydride or a halide of a polybasic carboxylic acid that can form an ester bond through condensation polymerization may be used instead of the polybasic carboxylic acid.

Preferable examples of the diols include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Preferable examples of the bisphenols include bisphenol A, hydrogenated bisphenol A, bisphenol A ethylene oxide adduct, and bisphenol A propylene oxide adduct.

Preferable examples of the tri- or higher-hydric alcohols include sorbitol, 1,2,3,6-hexanetetraol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Preferable examples of the dibasic carboxylic acid include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, dodecanedioic acid, alkyl succinic acids (specific examples include n-butylsuccinic acid, isobutylsuccinic acid, n-octylsuccinic acid, n-dodecylsuccinic acid, and isododecylsuccinic acid), and alkenyl succinic acid (specific examples include n-butenylsuccinic acid, isobutenylsuccinic acid, n-octenylsuccinic acid, n-dodecenylsuccinic acid, and isododecenylsuccinic acid).

Preferable examples of the tri- or higher-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and EMPOL trimer acid.

The binder resin may further contain a resin (additional resin) other than the polyester resin having an acid value of at least 10.0 mgKOH/g. Examples of the additional resin include a polyester resin having an acid value of less than 10.0 mgKOH/g, styrene-based resins, acrylic acid ester-based resins, olefin-based resin (specific examples include polyethylene resin and polypropylene resin), vinyl resins (specific examples include vinyl chloride resin, polyvinyl alcohol, vinyl ether resin, and N-vinyl resin), polyamide resin, and urethane resin. In addition, any of copolymers of the resins listed above, that is, copolymers including any repeating unit introduced into the resins listed above (specific examples include styrene-acrylic acid-based resins and styrene-butadiene-based resins) can be preferably used as the additional resin.

### (Positively Chargeable Charge Control Agent)

The positively chargeable charge control agent contains a compound having a quaternary ammonium cation group. In order to further inhibit occurrence of an image flow, the compound having a quaternary ammonium cation group is preferably at least one selected from the group consisting of resins each including a repeating unit derived from quaternary ammonium salt (also referred to below as a quaternary ammonium salt-based resin) and quaternary ammonium salt compounds including no repeating unit (also referred to below as a quaternary ammonium salt-based low-molecular compound). In order to further inhibit occurrence of an image flow, the toner mother particle preferably contains a quaternary ammonium salt-based resin as the positively chargeable charge control agent.

Examples of the quaternary ammonium salt-based resin include polymers of vinyl compounds having a quaternary ammonium cation group and copolymers of a vinyl compound having a quaternary ammonium cation group and another vinyl compound. Note that the vinyl compounds each are a compound having a vinyl group (CH₂═CH—) or a substituted vinyl group in which hydrogen is replaced (specific examples include ethylene, propylene, butadiene, vinyl chloride, (meth)acrylic acid, methyl (meth)acrylate, (meth)acrylonitrile, and styrene). A vinyl compound can be a macromolecule (resin) formed through addition polymerization of carbon-to-carbon double bond (C═C) included in the vinyl group or the like.

Examples of the vinyl compound having a quaternary ammonium cation group include vinylbenzyltrialkylammonium salts, 2-(acryloyloxy)ethyl trialkylammonium salts, and 2-(methacryloyloxy)ethyl trialkylammonium salts. Anions included in the above salts may each be an inorganic anion such as a halide ion or an organic anion such as a p-toluenesulfonic acid anion.

Examples of vinylbenzyltrialkylammonium salts include vinylbenzyltrimethylammonium salts (specific examples include vinylbenzyltrimethylammonium chloride), vinylbenzyltriethylammonium salts (specific examples include vinylbenzyltriethylammonium chloride), vinylbenzyldimethylethylammonium salts (specific examples include vinylbenzyldimethylethylammonium chloride), vinylbenzyldimethylisopropylammonium salts (specific examples include vinylbenzyldimethylisopropylammonium chloride), vinylbenzyl n-butyldimethylammonium salts (specific examples include vinylbenzyl n-butyldimethylammonium chloride), and vinylbenzyldimethylpentylammonium salts (specific examples include vinylbenzyldimethylpentylammonium chloride)

Examples of 2-(acryloyloxy)ethyl trialkylammonium salts include 2-(acryloyloxy)ethyl trimethylammonium salts (specific examples include 2-(acryloyloxy)ethyl trimethylammonium chloride), 2-(acryloyloxy)ethyl dimethylethylammonium salts (specific examples include 2-(acryloyloxy)ethyl dimethylethylammonium chloride), 2-(acryloyloxy)ethyl triethylammonium salts (specific examples include 2-(acryloyloxy)ethyl triethylammonium chloride), and 2-(acryloyloxy)ethyl dimethyl n-pentylammonium salts (specific examples include 2-(acryloyloxy)ethyl dimethyl n-pentylammonium chloride).

Examples of 2-(methacryloyloxy)ethyl trialkylammonium salts include 2-(methacryloyloxy)ethyl trimethylammonium salts (specific examples include 2-(methacryloyloxy)ethyl trimethylammonium chloride), 2-(mthacryloyloxy)ethyl dimethylethylammonium salts (specific examples include 2-(methacryloyloxy)ethyl dimethylethylammonium chloride), and 2-(methacryloyloxy)ethyl dimethyl n-pentylammounium salts (specific examples include 2-(methacryloyloxy)ethyl dimethyl n-pentylammonium chloride).

Examples of the additional vinyl compound capable of copolymerization with a vinyl compound having a quaternary ammonium cation group include: styrene-based compound such as styrene, o-methylstyrene, m-methylstyrene, p-methylstyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene; acrylic acid ester-based compounds such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, and phenyl (meth)acrylate; (meth)acrylic acid; and (meth) acrylonitrile. The vinyl compound having a quaternary ammonium cation group may be copolymerized with one of the additional vinyl compounds or copolymerized with two or more thereof.

Examples of the quaternary ammonium salt-based low-molecular compound include benzyldecylhexylmethyl ammonium chloride, decyltrimethyl ammonium chloride, 2-(methacryloyloxy)ethyl trimethylammonium chloride, and dimethylamino propyl acrylamide methyl chloride quaternary salt.

In a case where the toner mother particle contains a quaternary ammonium salt-based resin as the positively chargeable charge control agent, an amount of the quaternary ammonium salt-based resin is preferably at least 5.0 parts by mass relative to 100 parts by mass of the binder resin in order to easily ensure a charge amount suitable for image formation. In order to further inhibit occurrence of an image flow, an amount of the quaternary ammonium salt-based resin is preferably no greater than 15.0 parts by mass relative to 100 parts by mass of the binder resin.

In a case where the toner mother particle contains a quaternary ammonium salt-based low-molecular compound as the positively chargeable charge control agent, an amount of the quaternary ammonium salt-based low-molecular compound is preferably at least 0.5 parts by mass relative to 100 parts by mass of the binder resin in order to easily ensure a charge amount suitable for image formation. In order to further inhibit occurrence of an image flow, the amount of the quaternary ammonium salt-based low-molecular compound is preferably no greater than 3.0 parts by mass relative to 100 parts by mass of the binder resin.

The toner mother particle may further contain a positively chargeable charge control agent (additional positively chargeable charge control agent) other than the compound having a quaternary ammonium cation group. However, in order to easily ensure a charge amount suitable for image formation, the toner mother particle preferably contains only the compound having a quaternary ammonium cation group as the positively chargeable charge control agent.

Examples of the additional positively chargeable charge control agent include: azine compounds such as pyridazine, pyrimidine, pyrazine, 1,2-oxazine, 1,3-oxazine, 1,4-oxazine, 1,2-thiazine, 1,3-thiazine, 1,4-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes such as Azine Fast Red FC, Azine Fast Red 12BK, Azine Violet BO, Azine Brown 3G, Azine Light Brown GR, Azine Dark Green BH/C, Azine Deep Black EW, and Azine Deep Black 3RL; acid dyes such as Nigrosine BK, Nigrosine NB, and Nigrosine Z; metal salts of naphthenic acid; metal salts of higher organic carboxylic acid; alkoxylated amine; and alkylamide. Among above, one additional positively chargeable charge control agent may be used independently, or two or more additional positively chargeable charge control agents may be used in combination.

### (Strontium Titanate Particles)

Strontium titanate (composition formula: SrTiO₃) constituting the strontium titanate particles is one of titanate compounds. The strontium titanate particles may be subjected to surface treatment (for example, hydrophobitizing treatment). That is, the strontium titanate particles that can be used for the toner according to the first embodiment may be untreated strontium titanate particles or particles obtained by performing surface treatment on untreated strontium titanate particles (strontium titanate base).

No particular limitations are placed on a production method of the strontium titanate particles. Commercially available strontium titanate particles may be used for the toner according to the first embodiment.

An example of the production method of the strontium titanate particles is a method in which titanium oxide or metatitanic acid and strontium carbonate are mixed and baked. An example of a production method of fine strontium titanate particles is a thermal reaction method at normal pressure.

Examples of the thermal reaction method at normal pressure include: a method in which a titanium compound and a strontium compound are caused to react together in a strong alkaline aqueous solution; a method in which a titanium compound and a strontium compound are caused to wet react together in the presence of hydrogen peroxide; a method in which a solution of a strontium compound and a solution or a slurry of a titanium compound are mixed while being heated; and a method in which a strontium compound and a substance resulting from a titanium compound deflocculated with a mineral acid are mixed together and an alkaline aqueous solution is added to the resultant mixture while the resultant mixture is heated at a temperature of 50° C. or higher.

### (Colorant)

The toner mother particle may contain a colorant. The colorant can be a known pigment or dye that matches the color of the toner. The amount of the colorant is preferably at least 1 part by mass and no greater than 20 parts by mass relative to 100 parts by mass of the binder resin in order that a high-quality image is formed using the toner.

The toner mother particle may contain a black colorant. Carbon black can for example be used as a black colorant. A black colorant that is adjusted to a black color using a yellow colorant, a magenta colorant, and a cyan colorant can be used. A later-described magnetic powder may be used as a black colorant.

The toner mother particle may contain a non-black colorant. Examples of a non-black colorant include yellow colorants, magenta colorants, and cyan colorants.

At least one compound selected from the group consisting of condensed azo compounds, isoindolinone compounds, anthraquinone compounds, azo metal complexes, methine compounds, and arylamide compounds can be used as a yellow colorant. Examples of yellow colorants include C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, or 194), Naphthol Yellow S, Hansa Yellow G, and C.I. Vat Yellow.

At least one compound selected from the group consisting of condensed azo compounds, diketopyrrolopyrrole compounds, anthraquinone compounds, quinacridone compounds, basic dye lake compounds, naphthol compounds, benzimidazolone compounds, thioindigo compounds, and perylene compounds can be used as a magenta colorant. Examples of magenta colorants include C.I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221, or 254).

At least one compound selected from the group consisting of copper phthalocyanine compounds, anthraquinone compounds, and basic dye lake compounds can be used as a cyan colorant. Examples thereof include C.I. Pigment Blue (1, 7, 15, 15:1, 15:2, 15:3, 15:4, 60, 62, or 66), Phthalocyanine Blue, C.I. Vat Blue, and C.I. Acid Blue.

### (Releasing Agent)

The toner mother particle may contain a releasing agent. The releasing agent is for example used in order to obtain a toner having excellent offset resistance. The amount of the releasing agent is preferably at least 1 part by mass and no greater than 20 parts by mass relative to 100 parts by mass of the binder resin in order to obtain a toner having excellent offset resistance.

Examples of releasing agents include ester waxes, polyolefin wax (specific examples include polyethylene wax and polypropylene wax), microcrystalline wax, fluororesin wax, Fischer-Tropsch wax, paraffin wax, candelilla wax, montan wax, and castor wax. Examples of ester waxes include natural ester waxes (specific examples include carnauba wax and rice wax) and synthetic ester wax. A single releasing agent may be used independently, or two or more releasing agents may be used in combination.

A compatibilizer may be added to the toner mother particle in order to improve compatibility between the binder resin and the releasing agent.

### (Magnetic Powder)

The toner mother particle may contain a magnetic powder. Examples of materials of the magnetic powder include ferromagnetic metals (specific examples include iron, cobalt, and nickel) and alloys of ferromagnetic metals, ferromagnetic metal oxides (specific examples include ferrite, magnetite, and chromium dioxide), and material subjected to ferromagnetization (specific examples include carbon materials made ferromagnetic through thermal treatment). In the first embodiment, a single magnetic powder may be used independently or two or more magnetic powders may be used in combination. In order to obtain a toner suitable for image formation, the amount of the magnetic powder is preferably at least 50 parts by mass and no greater than 100 parts by mass relative to 100 parts by mass of the binder resin. A preferable amount range of a magnetic powder in a case where the magnetic powder functions as a black colorant is the same as above.

### (External Additive)

The toner particle included in the toner according to the first embodiment includes an external additive attached to the surface of the toner mother particle. The external additive includes no strontium titanate particles.

No particular limitations are placed on external additive particles included in the external additive where the external additive particles are particles other than strontium titanate particles. Among particles other than strontium titanate particles, inorganic particles other than titanium oxide particles are preferable. When the external additive particles are inorganic particles other than titanium oxide particles, the REACH regulation can be easily met. Examples of preferable inorganic particles other than titanium oxide particles include silica particles, aluminum oxide particles, magnesium oxide particles, zinc oxide particles, and barium titanate particles. In the first embodiment, one type of external additive particles may be used independently or two or more types of external additive particles may be used in combination.

In order to easily ensure a charge amount suitable for image formation, one or more types of particles selected from silica particles and aluminum oxide particles are preferable and aluminum oxide particles are more preferable.

The external additive particles may be surface-treated. For example, in a situation in which silica particles are used as the external additive particles, either or both of hydrophobicity and positive chargeability may be imparted to surfaces of the silica particles using a surface treatment agent. Examples of a surface treatment agent include coupling agents (specific examples include a silane coupling agent, a titanate coupling agent, and an aluminate coupling agent), silazane compounds (specific examples include a chain silazane compound and a ring silazane compound), and silicone oil (specific example include dimethyl silicone oil). One or more agents selected from silane coupling agents and silazane compounds are particularly preferable as the surface treatment agent. Preferable examples of the silane coupling agent include silane compounds (specific examples include methyltrimethoxysilane and aminosilane). Preferable examples of the silazane compound include hexamethyldisilazane (HMDS). When a surface of a silica base (untreated silica particles) is treated with the surface treatment agent, a large number of hydroxyl groups (—OH) on the surface of the silica base are partially or entirely replaced by functional groups derived from the surface treatment agent. As a result, silica particles having the functional groups derived from the surface treatment agent (specifically, functional groups that are more hydrophobic and/or more readily positively chargeable than the hydroxyl groups) on surfaces thereof are obtained.

In order to cause the external additive to sufficiently exhibit its function while inhibiting detachment of the external additive particles from the toner mother particles, the amount of the external additive particles is preferable at least 0.3 parts by mass and no greater than 10 parts by mass relative to 100 parts by mass of the toner mother particles.

### (Combination of Materials)

In order to easily ensure a charge amount suitable for image formation while further inhibiting occurrence of an image flow, it is preferable that the toner mother particle contains a quaternary ammonium salt-based resin as the positively chargeable charge control agent and the external additive contains silica particles and aluminum oxide particles as the external additive particles. In order to easily ensure a charge amount suitable for image formation while further inhibiting occurrence of an image flow, it is preferable that the toner mother particle contains, as the positively chargeable charge control agent, a copolymer of styrene, n-butyl acrylate, and 2-(methacryloyloxy)ethyl trialkylammonium salt and the external additive contains silica particles and aluminum oxide particles as the external additive particles.

### [Toner Production Method]

The following describes a preferable production method of the toner according to the first embodiment.

### (Preparation of Toner Mother Particles)

First, toner mother particles are prepared by an aggregation method or a pulverization method. The aggregation method includes an aggregation process and a coalescence process, for example. The aggregation process involves causing fine particles including components constituting the toner mother particles to aggregate in an aqueous medium to form aggregated particles. The coalescence process involves causing the components included in the aggregated particles to coalesce in the aqueous medium to form toner mother particles.

The following describes the pulverization method. According to the pulverization method, the toner mother particles can be relatively easily prepared and reduction in production cost is possible. In preparation of the toner mother particles by the pulverization method, a toner mother particle preparing process involves for example a melt-kneading process and a pulverizing process. The toner mother particle preparing process may further include a mixing process before the melt-knead process. The toner mother particle preparing process may further include at least one of a finely pulverizing process and a classifying process after the pulverizing process.

In the mixing process, the binder resin, the positively chargeable charge control agent, the strontium titanate particles, and an internal additive to be added as necessary are mixed together to obtain a mixture. In the melt-kneading process, toner materials are melted and kneaded to obtain a melt-kneaded substance. The mixture obtained in the mixing process is used for example as the toner material. In the pulverizing process, the resultant melt-kneaded substance is cooled to for example room temperature (25° C.) and then pulverized to obtain a pulverized product. When the pulverized product obtained by the pulverizing process is needed to be small in diameter, a process of further pulverizing the pulverized produce (the finely pulverizing process) may be performed. In order to equalize the particle size of the pulverized product, a process of classifying the resultant pulverized product (the classifying process) may be performed. Note that the melt-kneaded substance may be pulverized while being classified in the pulverizing process. As a result of the above processes performed, the toner mother particles that are the pulverized product are obtained.

### (External Addition Process)

Thereafter, the resultant toner mother particles and the external additive are mixed together using a mixer to attach the external additive to the surfaces of the toner mother particles. Through the above, the toner including the toner particles is produced.

### Second Embodiment: Image Forming Apparatus

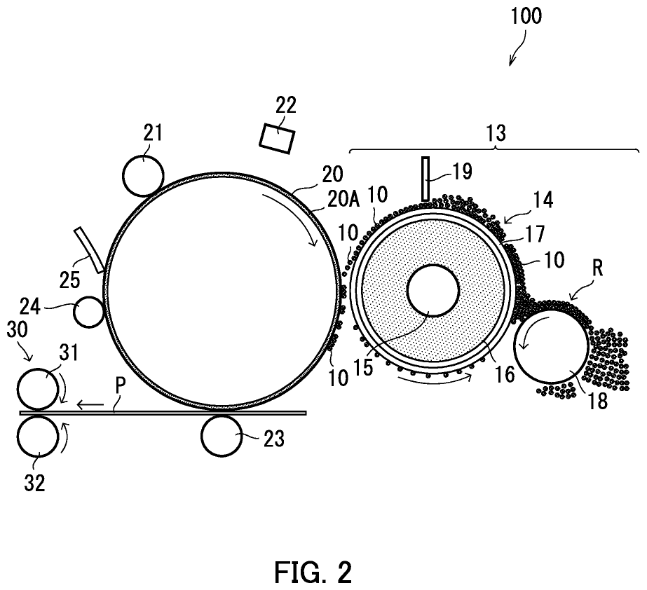

The following describes an example of an image forming apparatus according to a second embodiment of the present disclosure with reference to FIG. 2. The image forming apparatus according to the second embodiment is an image forming apparatus that forms an image using the toner according to the above-described first embodiment. Note that FIG. 2 schematically illustrates elements of configuration in order to facilitate understanding. Properties such as size and shape and the number of the elements of configuration illustrated in the drawing may differ from actual properties and the number thereof in order to facilitate preparation of the drawing.

As illustrated in FIG. 2, an image forming apparatus 100 includes a development device 13, a photosensitive drum 20 as an image bearing member, a charger 21, a light exposure device 22, a transfer roller 23, a cleaning blade 25, and a fixing device 30. The development device 13 includes a development roller 14, a toner supply roller 18, a toner charging member 19, and a toner accommodating section R. The photosensitive drum 20 includes a photosensitive layer 20A as a surface layer portion.

The charger 21 uniformly charges the photosensitive layer 20A of the photosensitive drum 20. The charger 21 is preferably a charger that charges the photosensitive layer 20A by contact charging (for example, a charging roller that charges the photosensitive layer 20A by application of direct current voltage or voltage that is direct current voltage superimposed by alternating current voltage). The light exposure device 22 selectively irradiates the photosensitive layer 20A uniformly and electrostatically charged by the charger 21 with light to form an electrostatic latent image. An LED head can be used for example as the light exposure device 22.

The toner accommodating section R of the development device 13 accommodates the toner according to the first embodiment (magnetic toner including the toner particles 10 that is an example of the above-described first embodiment in the image forming apparatus 100 illustrated in FIG. 2). Note that in a case where a two-component developer is used, the toner accommodating section R accommodates the two-component developer including a carrier and the toner according to the first embodiment.

The development device 13 supplies the toner to the electrostatic latent image formed on the surface of the photosensitive drum 20 to develop the electrostatic latent image into a toner image on the photosensitive drum 20. Specifically, the development device 13 develops the electrostatic latent image by a monocomponent magnetic jumping development system. The image forming apparatus 100 may include a toner container (not illustrated) for replenishing the toner accommodating section R of the development device 13 with the toner.

The development roller 14 includes a shaft 15, a magnet roll 16, and a cylindrical development sleeve 17. The development sleeve 17 is supported in a rotatable manner about the shaft 15 (fixed shaft). The development roller 14 is capable of carrying the toner supplied from the toner accommodating section R. The toner supply roller 18 supplies the toner accommodated in the toner accommodating section R to the development roller 14. The toner supply roller 18 may have a function of stirring a developer (magnetic toner). The toner charging member 19 (for example, a doctor blade) charges the toner borne on the surface of the development roller 14. The toner charging member 19 acts to urge the toner (specifically, magnetic toner) against the development sleeve 17. The toner charging member 19 may have a function of restricting the amount of the toner (thickness of a toner layer) on the development roller 14. The toner charging member 19 is formed from for example ferromagnetic material. The toner before being supplied to the photosensitive drum 20 is positively charged in the development device 13 by friction with the development sleeve 17 or the toner charging member 19.

In development by the development device 13, the toner (specifically, charged toner) on the development sleeve 17 is supplied to the photosensitive drum 20, and the supplied toner is selectively attached to an exposed portion of the electrostatic latent image formed on the photosensitive layer 20A of the photosensitive drum 20.

The transfer roller 23 is located opposite to the photosensitive drum 20. A conveyance path for a recording medium P (transfer target) is provided between the transfer roller 23 and the photosensitive drum 20 to allow the recording medium P to pass between the transfer roller 23 and the photosensitive drum 20. Bias (voltage) is applied to the transfer roller 23 with a specific timing. As a result of bias (voltage) application, the transfer roller 23 transfers the toner on the photosensitive drum 20 to the recording medium P (specifically, the recording medium P located between the photosensitive drum 20 and the transfer roller 23) by electric power (specifically, potential difference between the photosensitive drum 20 and the recording medium P). That is, the transfer roller 23 corresponds to a transfer section in the image forming apparatus 100 illustrated in FIG. 2.

The fixing device 30 includes a first roller 31 (for example, a heating roller including a heater) and a second roller 32 (for example, a non-heating roller including no heater). The fixing device 30 fixes the toner image to the recording medium P by sandwiching the recording medium P in a manner that the toner image (specifically, the toner image transferred to the recording medium P in the transfer process) on the surface (surface on a side of the recording medium P facing the photosensitive drum 20) comes in contact with the first roller 31 while an opposite surface of the recording medium P comes in contact with the second roller 32.

The cleaning blade 25 removes unnecessary toner on the photosensitive drum 20 (residual toner attached to the surface of the photosensitive drum 20) after the transfer process by the transfer roller 23.

The image forming apparatus 100 further includes a rubbing roller 24 that rubs the surface of the photosensitive drum 20. Specifically, the rubbing roller 24 is in press contact with the surface of the photosensitive drum 20 to rub the surface of the photosensitive drum 20 after the toner image has been transferred to the recording medium P. The rubbing roller 24 is located downstream of the transfer roller 23 (transfer section) in terms of a rotational direction of the photosensitive drum 20 and upstream of the cleaning blade 25 in terms of the rotational direction of the photosensitive drum 20. For example, the rubbing roller 24 includes a metal shaft having a surface covered with an elastic member made from for example foamed urethane. The rubbing roller 24 is rotatable while being in contact with the surface of the photosensitive drum 20.

When toner remaining on the surface of the photosensitive drum 20 is attached to the roller surface of the rubbing roller 24, a toner layer having uniform thickness is formed on the roller surface of the rubbing roller 24. The toner layer includes toner particles 10. The toner particles 10 include strontium titanate particles. Among the strontium titanate particles included in the toner particles 10, strontium titanate particles partially exposed at the surface of the toner mother particles function as an abrasive. The rubbing roller 24 rubs the surface of the photosensitive drum 20 with the toner attached to the roller surface to abrade the surface of the photosensitive drum 20 using the strontium titanate particles as an abrasive in the toner attached to the roller surface. The rotational speed of the rubbing roller 24 is preferably higher than that of the photosensitive drum 20. A difference in rotational speed as above can achieve unerring abrasion of the surface of the photosensitive drum 20 by the rubbing roller 24. The rubbing roller 24 abrades the surface of the photosensitive drum 20 to remove ionic materials (particularly, a discharge product generated in charging the photosensitive layer 20A of the photosensitive drum 20) attached to the surface of the photosensitive drum 20 in the process of image formation.

As described above, the strontium titanate particles have a function as an adsorbent that adsorbs the ionic materials attached to the surface of the photosensitive drum 20 in addition to a function as an abrasive for abrading the surface of the photosensitive drum 20. Accordingly, when the surface of the photosensitive drum 20 is abraded using the strontium titanate particles as an abrasive, the ionic materials attached to the surface of the photosensitive drum 20 can be easily removed in the process of image formation. The ionic materials present on the surface of the photosensitive drum 20 can be unerringly removed by the image forming apparatus 100, and thus, occurrence of an image flow can be inhibited.

Furthermore, a portion of the toner mother particles is clashed by the rubbing roller 24 of the image forming apparatus 100. When a portion of the toner mother particles are clashed, the strontium titanate particles separated from the clashed toner mother particles reach a location between the photosensitive drum 20 and the cleaning blade 25 to abrade the surface of the photosensitive drum 20 (or adsorb the ionic materials present on the surface of the photosensitive drum 20). Thus, the ionic materials present on the surface of the photosensitive drum 20 can be also removed in removing residual toner by the cleaning blade 25 in the image forming apparatus 100.

Examples of the photosensitive layer 20A of the photosensitive drum 20 include a photosensitive layer containing amorphous silicon and a photosensitive layer containing an organic photoconductor. Usually, in a photosensitive member including a photosensitive layer containing amorphous silicon as a surface layer portion (also referred to below as an amorphous silicon photosensitive member), a surface of the photosensitive layer is relatively high in hydrophilicity. Therefore, discharge products tend to be attached to the surface of the photosensitive layer, thereby readily causing an image flow. By contrast, the image forming apparatus 100 forms a toner image using the above-described toner according to the first embodiment. Therefore, occurrence of an image flow can be inhibited even with use of the amorphous silicon photosensitive member.

Moreover, the image forming apparatus 100 forms an image using the above-described toner according to the first embodiment. The toner according to the first embodiment can ensure an amount of charge suitable for image formation, as described above. Therefore, the image forming apparatus 100 can form high-quality images (for example, having an image density in an appropriate range).

### Third Embodiment: Image Formation Method

The following describes an image formation method according to a third embodiment of the present disclosure. The image formation method according to the third embodiment is a method for forming an image using the image forming apparatus according to the second embodiment. An example of the image formation method according to the third embodiment will be described below.

An example of the image formation method according to the third embodiment includes a developing process and a transfer process. In the developing process, the above-described toner according to the first embodiment is supplied to an electrostatic latent image formed on the surface of an image bearing member (for example, the photosensitive drum 20 illustrated in FIG. 2) to develop the electrostatic latent image into a toner image. In the transfer process, the toner image is transferred to a transfer target (for example, the recording medium P illustrated in FIG. 2).

In an example of the image formation method according to the third embodiment, development is performed using the above-described toner according to the first embodiment. For the same reason as that applied to the image forming apparatus 100, the image formation method according to the third embodiment can form high-quality images (for example, having an image density in an appropriate range) while inhibiting occurrence of an image flow.

### EXAMPLES

The following describes examples of the present disclosure. However, the present disclosure is not limited to the scope of the examples.

### <Synthesis of Polyester Resin>

### [Synthesis of Polyester Resin P1]

A four-necked flask (capacity: 5 L) was charged with 1,245 g of terephthalic acid, 1,245 g of isophthalic acid, 1,248 g of a bisphenol A ethylene oxide adduct (average number of moles added of ethylene oxide: 2 moles), and 744 g of ethylene glycol. Subsequently, a nitrogen atmosphere was maintained in the flask and the internal temperature of the flask was increased up to 250° C. while the flask contents were stirred. Thereafter, a reaction was caused for 4 hours under conditions of normal pressure and a temperature of 250° C. Then, 0.875 g of antimony trioxide, 0.548 g of triphenyl phosphate, and 0.102 g of tetrabutyl titanate were further added into the flask. Subsequently, the internal pressure of the flask was reduced to 0.04 kPa and the internal temperature of the flask was increased to 280° C. A reaction was then caused for 6 hours. Next, 30.0 g of trimellitic acid (a cross-linking agent) was further added into the flask. The internal pressure of the flask was returned to normal pressure and the internal temperature of the flask was reduced to 270° C. Then, a reaction was caused for 1 hour. After the reaction ended, a reaction product was taken out of the flask and cooled to obtain a polyester resin P1 as a binder resin. The resultant polyester resin P1 had a glass transition point (Tg) of 53.8° C., a softening point (Tm) of 100.5° C., a number average molecular weight (Mn) of 1,295, a mass average molecular weight (Mw) of 14,500, a molecular weight distribution (Mw/Mn) of 11.2, an acid value of 16.8 mgKOH/g, and a hydroxyl value of 22.8 mgKOH/g.

### [Synthesis of Polyester Resin P2]

A polyester resin P2 was obtained by the same synthesis method as that for the polyester resin P1 in all aspects other than that the reaction time after the internal temperature of the flask was increased to 280° C. was changed to 8 hours and an amount of trimellitic acid was changed to 11.0 g. The resultant polyester resin P2 had a glass transition point (Tg) of 52.1° C., a softening point (Tm) of 95.5° C., a number average molecular weight (Mn) of 1,125, a mass average molecular weight (Mw) of 11,800, a molecular weight distribution (Mw/Mn) of 10.5, an acid value of 11.6 mgKOH/g, and a hydroxyl value of 23.5 mgKOH/g.

### [Synthesis of Polyester Resin P3]

A polyester resin P3 was obtained by the same synthesis method as that for the polyester resin P1 in all aspects other than that the reaction time after the internal temperature of the flask was increased to 280° C. was changed to 4 hours and an amount of trimellitic acid was changed to 45.0 g. The resultant polyester resin P3 had a glass transition point (Tg) of 52.1° C., a softening point (Tm) of 95.5° C., a number average molecular weight (Mn) of 1,325, a mass average molecular weight (Mw) of 16,800, a molecular weight distribution (Mw/Mn) of 12.7, an acid value of 19.5 mgKOH/g, and a hydroxyl value of 22.1 mgKOH/g.

### [Synthesis of Polyester Resin P4]

A four-necked flask (capacity 5 L) was charged with 1,245 g of sebacic acid, 1,245 g of dodecanoic diacid, 1,248 g of 1,4-butanediol, and 744 g of 1,6-hexanediol. Subsequently, a nitrogen atmosphere was maintained in the flask and the internal temperature of the flask was increased up to 250° C. while the flask contents were stirred. Thereafter, a reaction was caused for 4 hours under conditions of normal pressure and a temperature of 250° C. Subsequently, 0.875 g of tetramethyl titanate, 0.548 g of diisooctyl phosphate, and 0.102 g of triphenyl phosphate were added into the flask. Subsequently, the internal pressure of the flask was reduced to 0.04 kPa and the internal temperature of the flask was increased to 280° C. A reaction was then caused for 6 hours. Then, 30.0 g of trimellitic acid (a cross-linking agent) was added into the flask. The internal pressure of the flask was returned to normal pressure and the internal temperature of the flask was reduced to 270° C. Then, a reaction was caused for 1 hour. After the reaction ended, a reaction product was taken out of the flask and cooled to obtain a polyester resin P4 as a binder resin. The resultant polyester resin P4 had a glass transition point (Tg) of 52.6° C., a softening point (Tm) of 106.2° C., a number average molecular weight (Mn) of 1,250, a mass average molecular weight (Mw) of 13,500, a molecular weight distribution (Mw/Mn) of 10.8, an acid value of 15.2 mgKOH/g, and a hydroxyl value of 18.6 mgKOH/g.

### [Synthesis of Polyester Resin P5]

A polyester resin P5 was obtained by the same synthesis method as that for the polyester resin P1 in all aspects other than that the reaction time after the internal temperature of the flask was increased to 280° C. was changed to 9 hours and an amount of trimellitic acid was changed to 7.0 g. The resultant polyester resin P5 had a glass transition point (Tg) of 51.9° C., a softening point (Tm) of 82.2° C., a number average molecular weight (Mn) of 1,065, a mass average molecular weight (Mw) of 10,600, a molecular weight distribution (Mw/Mn) of 10.0, an acid value of 7.2 mgKOH/g, and a hydroxyl value of 24.1 mgKOH/g.

### <Toner Production>

The following describes production methods of toners TA-1 to TA-10 and TB1 to TB-5.

### [Production of Toner TA-1]

### (Preparation of Toner Mother Particles)

Using an FM mixer (“FM-20B”, product of Nippon Coke & Engineering Co., Ltd.), 100 parts by mass of the polyester resin P1, 90.0 parts by mass of a magnetic powder (magnetite: “TN-15”, product of Mitsui Mining & Smelting Co., Ltd.), 10.0 parts by mass of a positively chargeable charge control agent (“ACRYBASE (registered Japanese trademark) FCA-201-PS”, product of FUJIKURA KASEI CO., LTD., component: copolymer of styrene, n-butyl acrylate, and 2-(methacryloyloxy)ethyl trialkylammonium salt), 4.0 parts by mass of a releasing agent (carnauba wax: product of TOA KASEI CO., LTD.), and 10.0 parts by mass of strontium titanate particles (“HPST-1S”, product of FUJI TITANIUM INDUSTRY CO.,LTD., number average primary particle diameter: 400 nm) were mixed together for 4 minutes at a rotational speed of 200 rpm.

Subsequently, the resultant mixture was melt-kneaded under conditions of a material feeding speed of 50 g/minute, a shaft rotational speed of 100 rpm, and a melt-kneading temperature (cylinder temperature) of 100° C. using a twin screw extruder (“TEM-26SS”, product of Toshiba Machine Co., Ltd.). The resultant melt-kneaded substance was then cooled. Subsequently, the cooled melt-kneaded substance was charged into a jet mill (“MJT-1”, product of Hosokawa Micron Corporation) for pulverization and classification. Through the above, toner mother particles having a volume median diameter (D₅₀) of 8 μm were obtained.

### (External Addition Process)

An external addition process was performed next on the resultant toner mother particles. Specifically, 100 parts by mass of the toner mother particles, 0.6 parts by mass of silica particles (“AEROSIL (registered Japanese trademark) RA200”, product of Nippon Aerosil Co., Ltd.), and 0.6 parts by mass of aluminum oxide particles (“AEROXIDE (registered Japanese trademark) ALU C”, product of Nippon Aerosil Co., Ltd.) were mixed together for 5 minutes at a rotational speed of 2,000 rpm using an FM mixer (“FM-10B”, product of Nippon Coke & Engineering Co., Ltd.) to attach a total amount of an external additive to the surfaces of the toner mother particles.

Next, sifting was performed on the resultant powder using a 200-mesh sieve (opening 75 μm). Through the above, a positively chargeable toner TA-1 was produced. Note that a composition ratio of components constituting the toner was not changed.

[Production of Toners TA-2 to TA-10 and TB-1 to TB-3]

The toners TA-2 to TA-10 and TB-1 to TB-3 were produced by the same method as that for the toner TA-1 in all aspects other than types of polyester resin, types and amounts of positively chargeable charge control agent, and amounts of strontium titanate particles as an internal additive were as shown in Table 1. Note that no strontium titanate particles were used in production of the toner TB-1. The produced toners TA-2 to TA-10 and TB-1 to TB-3 were each a positively chargeable toner. In Table 1, PS represents a copolymer of styrene, n-butyl acrylate, and 2-(methacryloyloxy)ethyl trialkylammonium salt (“ACRYBASE (registered Japanese trademark) FCA-201-PS”, product of FUJIKURA KASEI CO., LTD.). Also in Table 1, P-51 represents a quaternary ammonium salt-based low-molecular compound (“BONTRON (registered Japanese trademark) P-51”, product of ORIENT CHEMICAL INDUSTRIES, Co., Ltd.). Also in Table 1, each amount of the positively chargeable charge control agent and the strontium titanate particles is a number of parts by mass relative to 100 parts by mass of polyester resin.

### [Production of Toner TB-4]

A positively chargeable toner TB-4 was produced by the same method as that for the toner TA1 in all aspects other than the following changes.

### (Changes)

No strontium titanate particles were used in preparation of the toner mother particles in production of the toner TB-4. In the external addition process in production of the toner TB-4, 0.8 parts by mass of strontium titanate particles (“HPST-1S”, product of FUJI TITANIUM INDUSTRY CO., LTD.) were attached (externally added) to the surfaces of the toner mother particles in addition to 0.6 parts by mass of silica particles, and 0.6 parts by mass of aluminum oxide particles.

### [Production of Toner TA-5]

The positively chargeable toner TB-5 was produced by the same method as for the toner TA-1 in all aspects other than that 3.0 parts by mass of titanium oxide particles (“AEROXIDE (registered Japanese trademark) TiO₂ P25”, product of Nippon Aerosil Co., Ltd.) were used instead of 10.0 parts by mass of strontium titanate particles in preparation of toner mother particles.

TABLE 1

| | | | | | Amount of |
|---|---|---|---|---|---|
| | | | Positively chargeable | | strontium |
| | | | charge control agent | | titanate |
| | Polyester resin | | | Amount | particles |
| | | Acid value | | [parts by | [parts by |
| Toner | Type | [mgKOH/g] | Type | mass] | mass] |
| TA-1 | P1 | 16.8 | PS | 10.0 | 10.0 |
| TA-2 | P2 | 11.6 | PS | 10.0 | 10.0 |
| TA-3 | P3 | 19.5 | PS | 10.0 | 10.0 |
| TA-4 | P1 | 16.8 | PS | 5.0 | 10.0 |
| TA-5 | P1 | 16.8 | PS | 15.0 | 10.0 |
| TA-6 | P1 | 16.8 | P-51 | 0.5 | 10.0 |
| TA-7 | P1 | 16.8 | P-51 | 3.0 | 10.0 |
| TA-8 | P1 | 16.8 | PS | 10.0 | 20.0 |
| TA-9 | P1 | 16.8 | PS | 10.0 | 5.0 |
| TA-10 | P4 | 15.2 | PS | 10.0 | 10.0 |
| TB-1 | P1 | 16.8 | PS | 10.0 | Not used |
| TB-2 | P5 | 7.2 | PS | 10.0 | 10.0 |
| TB-3 | P5 | 7.2 | PS | 5.0 | 10.0 |
| TB-4 | P1 | 16.8 | PS | 10.0 | Not used as |
| | | | | | internal additive |
| | | | | | (used as external |
| | | | | | additive) |
| TB-5 | P1 | 16.8 | PS | 10.0 | Not used (titanate |
| | | | | | oxide particles |
| | | | | | were used) |

### <Evaluation Method>

The following describes evaluation methods for samples (the toners TA-1 to TA-10 and TB-1 to TB-5).

### [Image Flow]

An evaluation apparatus used was an image forming apparatus that was a monochrome printer (“ECOSYS (registered Japanese trademark) LS-4200DN”, product of KYOCERA Document Solutions Inc., image bearing member: amorphous silicon photosensitive member) including a rubbing roller. The rubbing roller included a metal shaft and a foamed urethane layer covering the metal shaft. The evaluation apparatus further included a motor for rotating the metal shaft of the rubbing roller.

A toner (evaluation target: any of the toners TA-1 to TA-10 and TB-1 to TB-5) was loaded into a development device and a toner container of the evaluation apparatus.

Next, by using the evaluation apparatus, a printing durability test in which a band-shaped solid image is continuously printed on 5,000 sheets of printing paper (A4-size plain paper) in an environment at a temperature of 23° C. and a relative humidity of 55% was performed. The band-shaped solid image had the same length (a dimension of the printing paper in a longitudinal direction) as a total length of the printing paper and a width (a dimension of the printing paper in a short direction) of 20 mm.

After the image bearing member was taken out of the evaluation apparatus, the taken-out image bearing member was left for stand for 12 hours in an environment at a temperature of 28° C. and a relative humidity of 80%. The image bearing member left for stand for 12 hours was set in the evaluation apparatus, and a halftone image (image density: 50%) was output on the entirety of one sheet of printing paper (A4-size plain paper) in an environment at a temperature of 28° C. and a relative humidity of 80%. The output image was then visually observed for evaluation with reference to the following criteria.

### (Evaluation Criteria)

A (Good): The halftone image was output with no blurring and no image flow was recognized.

B (Poor): The output halftone image was blurred by an image flow.

### [Charge Amount]

The same evaluation apparatus as the evaluation apparatus used for image flow evaluation was used as an evaluation apparatus. A toner (evaluation target: any of the toners TA-1 to TA-10 and TB-1 to TB-5) was loaded into a development device of the evaluation apparatus. Next, by using the evaluation apparatus, a blank image was continuously output on 100 sheets of printing paper (A4-size plain paper) in an environment at a temperature of 23° C. and a relative humidity of 55% to drive the development device of the evaluation apparatus.

Toner attached to a development sleeve of the development device of the evaluation apparatus was taken out when the image has been output on the first sheet and when the image has been output on the 100-th sheet in the output of the blank image. Then, a charge amount of the taken out toner was measured using a compact toner draw-off charge measurement system (“MODEL 212HS”, product of TREK, INC.) in an environment at a temperature of 23° C. and a relative humidity of 55%. In the following, a charge amount measured when the image has been output on the first sheet was referred to as an “initial charge amount E1” (or simply, “E1”). Also, a charge amount measured when the image has been output on the 100-th sheet was referred as a “post-continuous output charge amount E2” (or “E2” simply).

### (Evaluation Criteria)

Both the initial charge amount E1 and the post-continuous-printing charge amount E2 being at least 5.0 μC/g is evaluated as a charge amount suitable for image formation being able to be ensured. By contrast, at least one of the initial charge amount E1 and the post-continuous-printing charge amount E2 being less than 5.0 μC/g is evaluated as a charge amount suitable for image formation being unable to be ensured.

[Image Density]

The same evaluation apparatus as the evaluation apparatus used for image flow evaluation was used as an evaluation apparatus. A toner (evaluation target: any of the toner TA-1 to TA-10 and TB-1 to TB-5) was loaded into the developing device of the evaluation apparatus. Then, by using the evaluation apparatus, a solid image having a size of 25 mm×25 mm was formed on one sheet of printing paper (A4-size plain paper) under a condition of a toner application amount of 6.0 g/m² in an environment at a temperature of 25° C. and a relative humidity of 55%. An image density (also referred to below as an initial ID) of the formed solid image was then measured using a white photometer (“TC-6D”, product of Tokyo Denshoku Co., Ltd.).

Next, by using the evaluation apparatus, a blank image was continuously output on 100 sheets of printing paper (A4-size plain paper) in an environment at a temperature of 23° C. and a relative humidity of 55% to drive the development device of the evaluation apparatus. Then, a solid image having a size of 25 mm×25 mm was formed on one sheet of printing paper (A4-size plain paper) under a condition of a toner application amount of 6.0 g/m² in an environment at a temperature of 23° C. and a relative humidity of 55%. An image density (also referred to below as a post-continuous-output ID) of the formed solid image was then measured using a white photometer (“TC-6D”, product of Tokyo Denshoku Co., Ltd.).

### (Evaluation Criteria)

Both the initial ID and the post-continuous-printing ID being at least 1.10 was evaluated as a high-quality image being able to be formed. By contrast, at least one of the initial ID and the post-continuous-printing ID being less than 1.10 was evaluated as a high-quality image not being able to be formed.

### [Low-Temperature Fixability]

An evaluation apparatus used was an image forming apparatus that was the evaluation apparatus used for image flow evaluation modified to be changeable in fixing temperature.

A toner (evaluation target: any of the toner TA-1 to TA-10 and TB-1 to TB-5) was loaded into a developing device and a toner container of the evaluation apparatus. Next, by using the evaluation apparatus, a solid image having a size of 25 mm×25 mm (specifically, an unfixed toner image before having passing through a fixing device) was formed on paper (“NAUTILUS”, product of Mondi Limited, size: A4, basis weight: 80 g/m²) under a condition of a toner application amount of 0.4 mg/cm² in an environment at a temperature of 23° C. and a relative humidity of 55%. The printing paper with the solid image formed thereon was passed through the fixing device of the evaluation apparatus. In so doing, while the fixing temperature of the fixing device was increased at an increment of 1° C. from 170° C., whether or not the toner was fixed was determined for each fixing temperature to measure the lowest temperature (minimum fixable temperature) at which the solid image (toner image) could be fixed to the paper.

Whether or not the toner could be fixed was confirmed by the following rubbing test. Specifically, an image density (also referred to below as pre-rubbing ID) of the solid image on the paper having passed through the fixing device was measured using a white photometer (“TC-6D”, product of Tokyo Denshoku Co., Ltd.). A 1-kg weight covered with cloth was rubbed back and forth on the image on the paper 10 times. Sequentially, an image density (also referred to below as post-rubbing ID) of the solid image on the paper was measured using the white photometer (“TC-6D”, product of Tokyo Denshoku Co., Ltd.). A fixing ratio (unit: %) was calculated in accordance with an equation “(fixing ratio)=100×(post-rubbing ID)/(pre-rubbing ID)”. The lowest temperature among fixing temperatures for which the fixing ratio was at least 90% was taken to be a minimum fixable temperature. If the minimum fixable temperature was 220° C. or lower, the low-temperature fixability was evaluated as “good”. If the minimum fixable temperature was higher than 220° C., the low-temperature fixability was evaluated as “poor”.

### <Evaluation Results>

Evaluation results of the image flow, charge amount, image density, and minimum fixable temperature for each of the toners TA-1 to TA-10 and TB-1 to TB-5 were shown in Table 2.

TABLE 2

| | | | Charge | | | | Minimum |
|---|---|---|---|---|---|---|---|
| | | | amount | | Image density | | fixable |
| | | Image | [μC/g] | | Initial | Post-continuous-output | temperature |
| | Toner | flow | E1 | E2 | ID | ID | [° C.] |
| Example 1 | TA-1 | A | 8.2 | 6.4 | 1.20 | 1.12 | 195 |
| Example 2 | TA-2 | A | 8.5 | 6.7 | 1.30 | 1.15 | 192 |
| Example 3 | TA-3 | A | 7.4 | 6.2 | 1.20 | 1.12 | 190 |
| Example 4 | TA-4 | A | 7.2 | 5.8 | 1.20 | 1.10 | 193 |
| Example 5 | TA-5 | A | 8.5 | 6.0 | 1.20 | 1.12 | 192 |
| Example 6 | TA-6 | A | 7.6 | 6.5 | 1.18 | 1.12 | 190 |
| Example 7 | TA-7 | A | 7.8 | 7.2 | 1.24 | 1.18 | 192 |
| Example 8 | TA-8 | A | 7.7 | 5.8 | 1.20 | 1.13 | 220 |
| Example 9 | TA-9 | A | 6.8 | 6.2 | 1.18 | 1.15 | 190 |
| Example 10 | TA-10 | A | 8.0 | 6.1 | 1.21 | 1.11 | 195 |
| Comparative | TB-1 | B | 7.8 | 6.5 | 1.22 | 1.13 | 188 |
| Example 1 | | | | | | | |
| Comparative | TB-2 | B | 7.6 | 6.2 | 1.20 | 1.15 | 195 |
| Example 2 | | | | | | | |
| Comparative | TB-3 | B | 7.5 | 5.8 | 1.15 | 1.10 | 188 |
| Example 3 | | | | | | | |
| Comparative | TB-4 | A | 7.6 | 3.2 | 1.20 | 0.81 | 185 |
| Example 4 | | | | | | | |
| Comparative | TB-5 | B | 8.3 | 5.7 | 1.23 | 1.11 | 190 |
| Example 5 | | | | | | | |

In each of the toners TA-1 to TA-10, the toner particles each include a toner mother particle and an external additive attached to a surface of the toner mother particle. In each of the toners TA-1 to TA-10, the toner mother particle includes a binder resin, a positively chargeable charge control agent, and strontium titanate particles. In each of the toners TA-1 to TA-10, a portion of the strontium titanate particles is partially exposed at the surface of the toner mother particle.

As shown in Table 1, the binder resin was a polyester resin having an acid value of at least 10.0 mgKOH/g in each of the toners TA-1 to TA-10. In each of the toners TA-1 to TA-10, the positively chargeable charge control agent was a compound having a quaternary ammonium cation group. The external additive in each of the toners TA-1 to TA-10 included no strontium titanate particles.

As shown in Table 2, the toners TA-1 to TA-10 were evaluated as A in image flow evaluation. Therefore, occurrence of an image flow can be inhibited in each of the toners TA-1 to TA-10. In each of the toners TA-1 to TA-10, both E1 and E2 were at least 5.0 μC/g. Therefore, a charge amount suitable for image formation can be ensured in each of the toners TA-1 to TA-10.

As shown in Table 1, the toner mother particle of each of the toners TB-1, TB-4, and TB-5 included no strontium titanate particles. In each of the toners TB-2 and TB-3, the binder resin was a polyester resin having an acid value of less than 10.0 mgKOH/g.

As shown in Table 2, the toners TB-1 to TB-3 and TB-5 each were evaluated as B in image flow evaluation. Therefore, occurrence of an image flow was not inhibited in each of the toners TB-1 to TB-3 and TB-5. E2 of the toner TB-4 was less than 5.0 μC/g. Therefore, a charge amount suitable for image formation could not be ensured in the toner TB-4.

From the above results, it was shown that the positively chargeable toner according to the present disclosure, which even uses strontium titanate particles, can ensure a charge amount suitable for image formation while occurrence of an image flow can be inhibited.

What is claimed is:

1. A positively chargeable toner comprising toner particles, wherein
the toner particles each include a toner mother particle and an external additive attached to a surface of the toner mother particle,
the toner mother particle includes a binder resin, a positively chargeable charge control agent, and strontium titanate particles,
the binder resin includes a polyester resin having an acid value of at least 10.0 mgKOH/g,
the positively chargeable charge control agent contains a compound having a quaternary ammonium cation group, and
the external additive includes no strontium titanate particles.

2. The positively chargeable toner according to claim 1, wherein
the strontium titanate particles are included in the toner mother particle in an amount of at least 5.0 parts by mass and no greater than 20.0 parts by mass relative to 100 parts by mass of the binder resin.

3. The positively chargeable toner according to claim 1, wherein
the compound having the quaternary ammonium cation group is a resin including a repeating unit derived from a quaternary ammonium salt.

4. The positively chargeable toner according to claim 3, wherein
an amount of the resin including the repeating unit derived from the quaternary ammonium salt is at least 5.0 parts by mass and no greater than 15.0 parts by mass relative to 100 parts by mass of the binder resin.

5. The positively chargeable toner according to claim 1, wherein
the external additive includes aluminum oxide particles.

6. The positively chargeable toner according to claim 1, wherein
the polyester resin has an acid value of no greater than 20.0 mgKOH/g.

7. The positively chargeable toner according to claim 1, wherein
the toner particles include no titanium oxide particles.

8. An image forming apparatus comprising:
an image bearing member;
a development device configured to develop an electrostatic latent image formed on a surface of the image bearing member into a toner image by supplying a toner to the electrostatic latent image; and
a transfer section configured to transfer the toner image to a transfer target, wherein
the toner is the positively chargeable toner according to claim 1.

9. The image forming apparatus according to claim 8, wherein
the image bearing member includes a photosensitive layer containing amorphous silicon at a surface layer portion thereof.

10. An image formation method comprising:
developing an electrostatic latent image formed on a surface of an image bearing member into a toner image by supplying a toner to the electrostatic latent image; and
transferring the toner image to a transfer target, wherein
the toner is the positively chargeable toner according to claim 1.
